(19) United States
(12) Patent Application Publication
(10) Pub. No.: US 2017/0317905 A1
(43) Pub. Date: Nov. 2, 2017

(54) METRIC FINGERPRINT IDENTIFICATION

(71) Applicant: HEWLETT PACKARD ENTERPRISE DEVELOPMENT LP, Houston, TX (US)

(72) Inventors: Joern Schimmelpfeng, Herrenberg (DE); Michael Tritschler, Holzgerlingen (DE); Laura Gonzalez Menendez, London (GB)

(21) Appl. No.: 15/143,357

(22) Filed: Apr. 29, 2016

(51) Int. Cl. H04L 12/26

(52) U.S. Cl. CPC H04L 43/0823; H04L 43/04

(57) ABSTRACT

A metric data stream from a computing device may be received over a collection period. Based on a first parameter and a second parameter extracted from the metric data stream, a metric descriptor of the metric data over the collection period may be generated. The metric descriptor may be concatenated with other metric descriptors of the metric data stream over other collection periods into a metric fingerprint representing a performance characteristic of the computing device. The metric fingerprint may be compared to at least one other metric fingerprint that represents the performance characteristic of another computing device. Based on the comparison, an anomaly in the performance characteristic of the other computing device may be identified.

### BACKGROUND

In some computing environments such as large data centers, monitoring application and device behaviors may include collecting significant amounts of metric data. In some examples, unusual behavior may be detected by the collected data. For example, individual data metrics may be monitored with respect to portions of collected data.

### BRIEF DESCRIPTION OF THE DRAWINGS

FIG. 1 is a block diagram of a system for identifying an anomaly in a performance characteristic of at least one computing device according to an example of the present disclosure.

FIG. 2 is a table showing parameters extracted from a metric data stream over collection periods according to an example of the present disclosure.

FIG. 3 is a table used to generate a metric descriptor of metric data according to an example of the present disclosure.

FIGS. 4, 5 and 6 illustrate metric data streams of network throughput for different webservers according to examples of the present disclosure.

FIG. 7 is a block diagram of a non-transitory machine-readable storage medium according to an example of the present disclosure.

FIG. 8 is a flow chart of a method for identifying an anomaly in a metric fingerprint according to an example of the present disclosure.

FIGS. 9A and 9B are a flow chart of a method for identifying an anomaly in a metric fingerprint according to an example of the present disclosure.

### DETAILED DESCRIPTION

Data centers, large networks and other computing device clusters continue to grow in size and complexity. In some examples, data monitoring tools, such as software agents, may monitor data that is transferred, received and/or generated by applications and associated hardware of such computing devices. Performance monitoring tools may analyze such data, along with transactions that are associated with the data, to identify performance characteristics and performance issues. Where data centers and corresponding applications are utilized to provide a service, such as on-line purchasing, on-line banking, etc., such monitoring data may help the service provider or application owner determine how well the system or application is functioning.

As data centers and computing clusters continue to grow, the amount of data generated and exchanged by such systems is correspondingly increasing. Many thousands of data metrics may be continuously generated and collected. Accordingly, monitoring the hardware and software running in a data center or other cluster, as well as efficiently analyzing the data collected, can prove challenging. For example, searching, finding and correcting issues with applications and/or hardware can be time-consuming and inefficient.

In some examples, complicated monitoring configurations have been utilized that do not perform well in large computing networks. For example, such configurations are unable to effectively search data in large networks to quickly identify a variety of unusual patterns or anomalies. Other examples have reached the limits of a system's computational resources, making it difficult or impossible in many cases to search, identify, and analyze more than a few thousand metrics. Some examples have utilized high level representations, such as spectral transformation, wavelets or linear approximation, to extract knowledge from data streams. These approaches, however, have proven insufficient when applied to large collections of data collected from data centers or other large clusters.

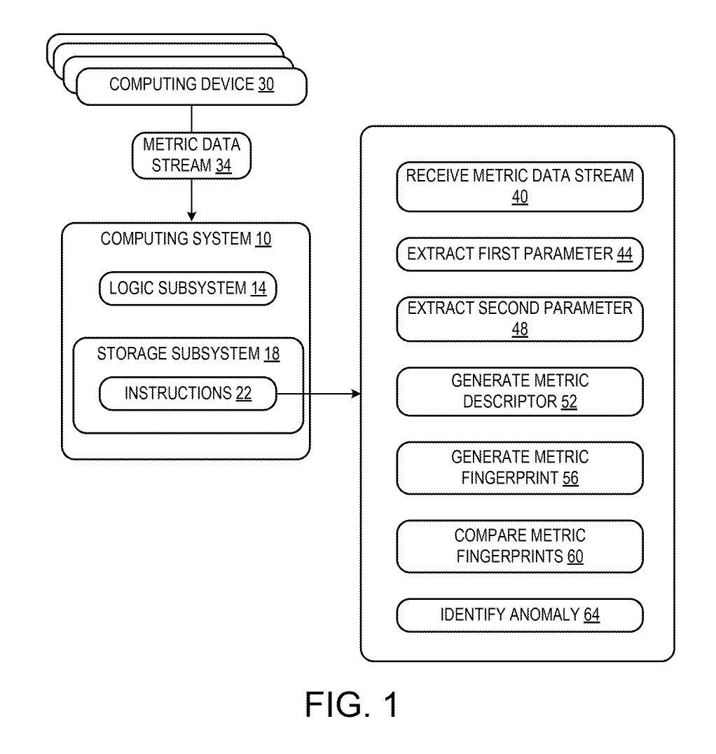

In some examples, the present disclosure is directed to identifying an anomaly in a performance characteristic of at least one computing device among a plurality of computing devices. With reference now to FIG. 1, a computing system 10 according to an example of the present disclosure is provided. Computing system 10 is shown in simplified form. Computing system 10 may take the form of at least one server computing device, network computing device, tablet computing device, home-entertainment computing device, mobile computing device, mobile communication device (e.g., smart phone), and/or other type of computing device.

Computing system 10 includes a logic subsystem 14 and a storage subsystem 18. Computing system 10 may include a display subsystem, input subsystem, communication subsystem, and/or other components not shown in FIG. 1. Logic subsystem 14 includes at least one physical device to execute instructions 22. Logic subsystem 14 may execute instructions that are stored on a non-transitory machine-readable storage medium. For example, logic subsystem 14 may be adapted to execute instructions that are part of at least one application, service, program, routine, library, object, component, data structure, or other logical construct. Such instructions may be implemented to perform a task, implement a data type, transform the state of components, achieve a technical effect, or otherwise arrive at a desired result.

Logic subsystem 14 may include a processor (or multiple processors) to execute machine-readable instructions. Additionally or alternatively, logic subsystem 14 may include hardware or firmware logic subsystems to execute instructions. Processors of logic subsystem 14 may be single-core or multi-core, and the instructions executed thereon may carry out sequential, parallel, and/or distributed processing. Individual components of logic subsystem 14 may be distributed among separate devices, which may be remotely located and/or arranged for coordinated processing. Aspects of logic subsystem 14 may be virtualized and executed by remotely accessible, networked computing devices in a cloud-computing configuration. In such an example, these virtualized aspects may be run on different physical logic processors of various different machines.

With continued reference to FIG. 1, logic subsystem 14 may be coupled to a storage subsystem 18 that stores instructions 22. As described in more detail below, in some examples the instructions 22 may be executed to identify an anomaly in a performance characteristic of at least one computing device. Storage subsystem 18 includes one or more physical devices to hold instructions 22 executable by logic subsystem 14 to implement the methods and processes described herein. When such methods and processes are implemented, the state of storage subsystem 18 may be transformed—e.g., to hold different data

Storage subsystem 18 may include removable and/or built-in devices. Storage subsystem 18 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 18 may include volatile, nonvolatile, dynamic, static, read/write, read-only, random-access, sequential-access, location-addressable, file-addressable, and/or content-addressable devices.

Aspects of logic subsystem 14 and storage subsystem 18 may be integrated together into hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 10 implemented to perform a particular function. In some cases, a program may be instantiated via logic subsystem 14 executing instructions held by storage subsystem 18. It will be understood that different programs may be instantiated from the same application, service, code block, object, library, routine, application program interface (API), function, etc. Likewise, the same program may be instantiated by different applications, services, code blocks, objects, routines, APIs, functions, etc. The term “program” may encompass individual or groups of executable files, data files, libraries, drivers, scripts, database records, etc.

As shown in FIG. 1, computing system 10 may be communicatively coupled to a plurality of computing devices 30, such as via a network. Computing system 10 may include wired and/or wireless communication functionality that is compatible with at least one communication protocol. In some examples, the computing system may communicate with computing devices 30 via a wireless local area network, a wired local area network, a wireless wide area network, a wired wide area network, a wireless telephone network, etc.

In various examples, computing devices 30 may comprise server computing devices, network computing devices, and/or any other type of computing device that may generate and/or collect metric data. Such computing devices 30 may be physically and/or virtually grouped into collections of computing devices, such as a data center, server farm, cluster of computing devices, or any other collection of computing devices, along with corresponding hardware and software. Agents deployed on computing system 10 and/or computing devices 30 may gather metric data representing different performance characteristics related to the computing devices 30, their components and/or applications and services provided by such devices. Examples of metric data include network throughput, processor usage, processor temperature, memory usage, application or service response times, transaction rates, website traffic metrics such as sessions, page views, etc. In other examples, other forms and types of metric data may be collected and analyzed as described herein.

As shown in FIG. 1, computing system 10 may receive a metric data stream 34 from the computing devices 30. Instructions 22 stored in storage subsystem 18 may include instructions 40 to receive the metric data stream 34 over a collection period for each computing device 30 of the plurality of computing devices. A collection period may be any suitable time period over which metric data is received, such as 5 seconds, 10 secs, 15 secs, 1 minute, 5 minutes, or any other suitable timeframe. For example, an agent may collect metric data from a computing device at a sampling rate of 10 Hz. In this example and over a collection period of 5 seconds, 50 metric data points may be received. In other examples, any suitable sampling rate and collection period may be utilized.

The metric data stream 34 may include random noise that can produce sharp, sudden changes in the data. In some examples the computing system 10 may smooth the metric data in the metric data stream 34 to reduce such noise. For example, and to facilitate analysis of trends in a function represented by the metric data stream 34, the data may be converted into a discrete time signal and passed through a low-pass frequency filter based on a Gaussian window. Any other suitable filtering technique that attenuate noise in the metric data stream signal may be utilized. In this manner, white noise disturbances in the signal may be attenuated or removed to yield a smoother signal.

As described in more detail below, for each computing device 30 from which metric data is received, parameters may be extracted for each collection period of a series of serially ordered collection periods. Together such serially ordered collection periods may define an observation period. The parameters extracted during each collection period within an observation period may be evaluated over the observation period. Metric descriptors of the metric data may be generated based on the extracted parameters. As described in more detail below, the metric descriptors representing a series of collection periods may be concatenated into a metric fingerprint that provides a set of values that effectively describe the metric data analyzed over the observation period.

In the example of FIG. 1, the instructions 22 may include instructions 44 to extract a first parameter from the metric data stream 34, and instructions 48 to extract a second parameter from the metric data stream. In some examples, the first parameter may comprise a number of maxima or minima in the metric data stream 34 within a collection period. A maximum or minimum may be defined by a magnitude of change of the first parameter within a window period that is shorter than the collection period.

For example, a function may represent the change in a performance characteristic over a collection period. In such a function, a maximum may correspond to a peak in the function. In one example where the performance characteristic is CPU usage and a collection period is 5 minutes, a peak may be defined as CPU usage increasing from 50% to at least 90% and then decreasing to at least 70% within one minute (e.g., a window period that is shorter than the collection period). Similarly, a minimum may correspond to a bottom point in a function that represents the change in the performance characteristic over a collection period. In one example, a minimum may be defined as CPU usage decreasing from 80% to at least 20% and then increasing back to 50% within 30 seconds minute. In other examples, any other suitable criteria for defining a data maximum may be utilized, and any other suitable criteria for defining a data minimum may be utilized.

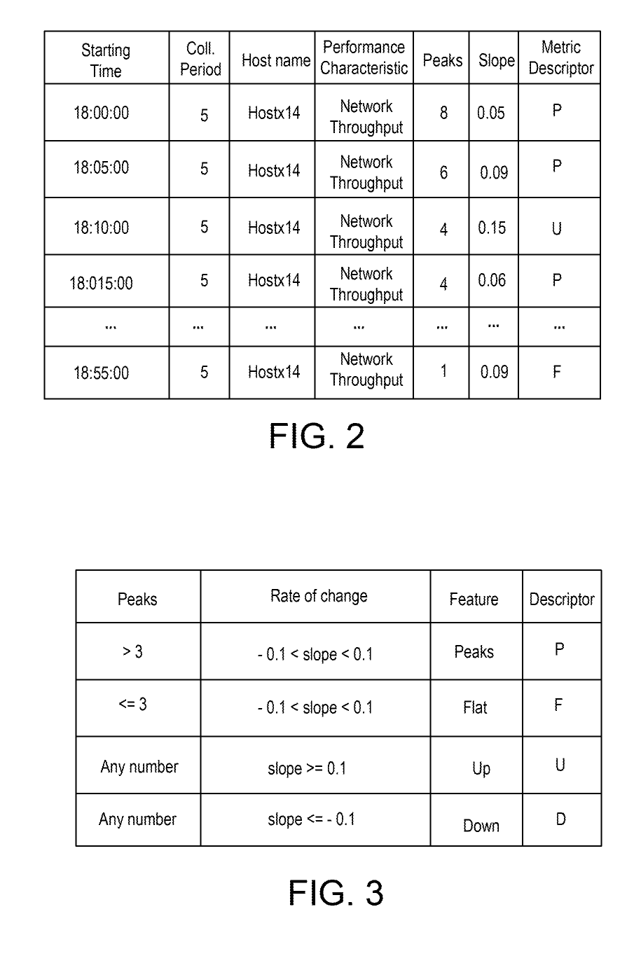

With reference now to FIG. 2, one example of metric data collected over a series of collection periods that define an observation period is provided. In this example, metric data from a metric data stream is received from a corresponding computing device denoted by Host Name Hostx14. The metric data is gathered over serially ordered collection periods of 5 minutes each beginning at 18:00:00 hours (6:00 pm). Network throughput (in Mbps) is the performance characteristic of the corresponding computing device that is reflected in the metric data stream. In this example the observation period is one hour (from 18:00:00 to 19:00:00), such that 12 serially ordered collection periods of 5 minutes each make up the observation period of one hour.

In this example, a maximum (Peak) of the network throughput metric data may be defined as network throughput increasing by at least 5 Mbps and then decreasing by at least 5 Mbps within the span of 10 seconds or less. As shown in FIG. 2, different collection periods may have the same or different number of peaks present within the period. In other examples, and in addition to or instead of determining a number of peaks for each collection period, a number of minima (bottom points) for each collection period may be determined.

In the present example, the second parameter extracted from the metric data stream 34 may comprise a slope or rate of change of the magnitude of the metric data stream over each collection period. The slope of the metric data stream may be defined as the average of the derivative function of the smoothed metric data stream signal over a collection period. For example and with reference again to the example of FIG. 2, for the collection period starting at 18:00:00 hours the slope is determined to be 0.05 over this 5 minute period.

With reference again to the example of FIG. 1, the instructions 22 may include instructions 52 to generate a metric descriptor of the metric data received in each of the collection periods. For example, based on the number of peaks in a collection period and the slope of the metric data stream over the collection period, a metric descriptor of the metric data received in each of the collection periods may be generated. In other words, the number of peaks and the slope of a collection period may be mapped to a metric descriptor. In some examples, the metric descriptor may comprise a single letter, number, or other symbol that relates to one or more aspects of a performance characteristic of a computing device.

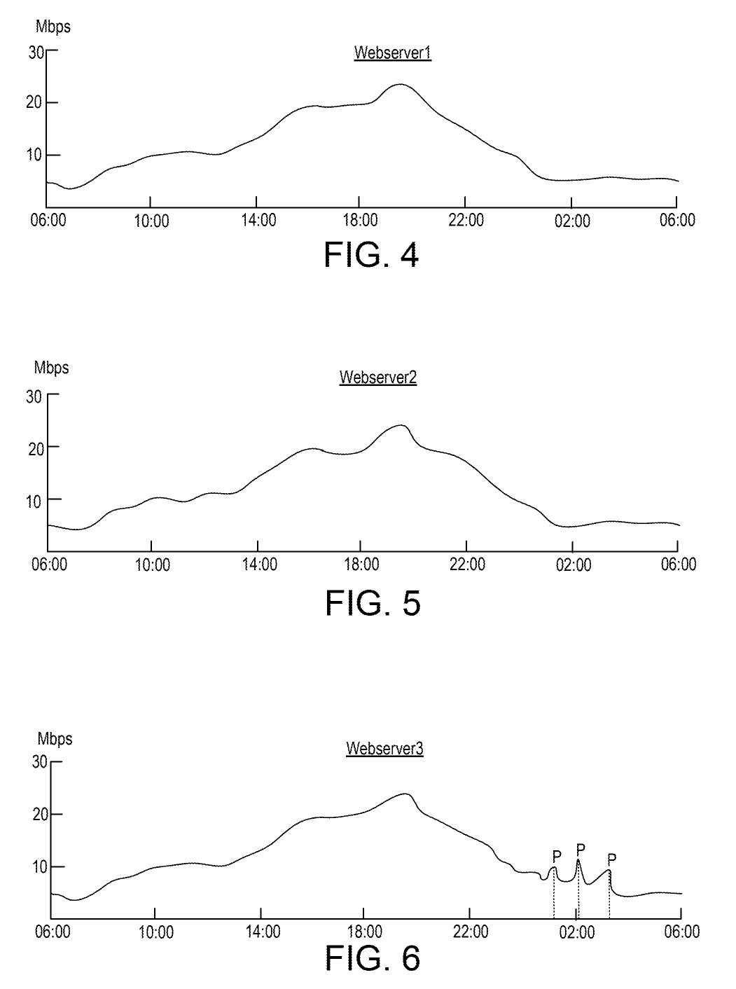

With reference now to FIG. 3, in one example 4 different metric descriptors in the form of letters P, F, U and D may be utilized. In this example, logic that maps the number of peaks and the slope of a collection period to one of the 4 metric descriptors may be configured to use a dominant parameter during the period, such as the number of peaks or the slope, to determine the metric descriptor. In one example, generating the metric descriptor of the metric data over the collection period comprises determining that the slope of the magnitude of the metric data stream over the collection period is within a predetermined range. In the example of FIG. 3, the predetermined range of slopes is −0.1<slope<0.1. In other examples, any suitable range of slopes may be utilized.

Next and based on determining that the slope is within the predetermined range, it is determined whether the number of the peaks (maxima) within the collection period exceeds a predetermined value. In the example of FIG. 3, the predetermined value is 3. In other examples, any suitable predetermined value may be utilized. Where the number of the maxima exceeds the predetermined value, a first metric descriptor may be generated. In the example of FIG. 3, the first metric descriptor is the letter P (corresponding to a prominent feature comprising many peaks in the data over the collection period). Where the number of the maxima does not exceed the predetermined value, a second metric descriptor may be generated. In the example of FIG. 3, the second metric descriptor is the letter F (corresponding to a prominent feature of the data being relatively flat over the collection period).

Where it is determined that the slope is not within the predetermined range, it is then determined whether the slope is greater than or less than the predetermined range. In the example of FIG. 3, where the slope is greater than or equal to 0.1, a third metric descriptor may be generated. In the example of FIG. 3, the third metric descriptor is the letter U (corresponding to a prominent feature of the data having an Upward slope over the collection period). In this example, the metric descriptor U is selected regardless of the number of Peaks over the collection period. Where the slope is less than or equal to −0.1, a fourth metric descriptor may be generated. In the example of FIG. 3, the fourth metric descriptor is the letter D (corresponding to a prominent feature of the data having a Downward slope over the collection period). In this example, the metric descriptor D is selected regardless of the number of Peaks over the collection period.

As noted above and in other examples, the number of minima also may be utilized instead of or in addition to the number of maxima in determining the metric descriptor for a collection period.

With reference again to the example of FIG. 1, the instructions 22 may include instructions 56 to generate a metric fingerprint comprising a concatenation of the metric descriptors for each of the collection periods, with the metric fingerprint representing the performance characteristic over an observation period. For example, in the present example and with a metric descriptor determined for each of the 12 collection periods over the one hour observation period, the 12 metric descriptors may be concatenated into a metric fingerprint that represents the performance characteristic of the computing device over the observation period. By utilizing a temporal arrangement of the 12 metric descriptors from beginning to end of the observation period, the metric fingerprint comprises a temporally-ordered sequence of the metric descriptors. In the example of FIG. 2, the metric fingerprint for the computing device Hostx14 over the observation period from 18:00:00 to 19:00:00 may be the symbolic sequence PPUPDDFFUUFF.

In some examples, multiple metric fingerprints from multiple computing devices may be compared to identify similarities and/or differences in the metric fingerprints and corresponding performance characteristics of the computing devices. With reference again to the example of FIG. 1, the instructions 22 may include instructions 60 to compare the metric fingerprint of each of the computing devices to the other metric fingerprints of each of the other computing devices. The instructions 22 also may include instructions 64 to identify, based on the comparisons, an anomaly in the performance characteristic of at least one computing device.

For example and continuing with the example above, computing device Hostx14 may have the metric fingerprint of PPUPDDFFUUFF over the one hour observation period from 18:00:00 to 19:00:00. Computing device Hostx14 may be one server among, for example, 100 servers that make up a data center that provides e-commerce services to customers in the Pacific time zone of the United States. The 100 servers may be operated behind a load balancer that distributes workloads across the servers to coordinate server use, maximize throughput, and minimize response time.

In some examples, the load balancer may be configured to distribute workloads across the 100 servers fairly equally. By determining metric fingerprints for each of the servers as described above, throughput performance of each of the servers may be easily and quickly compared to confirm a proper workload distribution or to identify one or more anomalies in the throughput of one or more of the servers. For example, the metric fingerprint PPUPDDFFUUFF for the Hostx14 computing device may be compared to the metric fingerprints for each of the other 99 servers. In one example, it may be determined whether each metric fingerprint for each of the other 99 servers matches exactly the metric fingerprint PPUPDDFFUUFF for the Hostx14 computing device. If an exact match does not exist, an anomaly may be identified for the corresponding computing device. Such an anomaly may be an indication of a misconfiguration of the load balancer, a security issue such as a DNS attack, or other performance issue with respect to the computing device.

In other examples, different degrees of similarity may be selected and easily searched for among the 100 servers. In some examples, approximate string matching among the 100 servers may be performed using one or more substrings of the temporally-ordered sequence of the metric descriptors of the metric fingerprint. For example and continuing with the example metric fingerprint PPUPDDFFUUFF for the Hostx14 computing device, a substring of metric descriptors PDDFFU may be extracted from the metric fingerprint PPUPDDFFUUFF and searched for among the other 99 servers. Any of the other 99 servers that have a metric fingerprint including the substring PDDFFU at any location within the fingerprint may be identified as having a similar performance characteristic. For example, a server having a metric fingerprint of PUPDDFFUUFFF, though not exactly matching the metric fingerprint PPUPDDFFUUFF for the Hostx14, still would be captured by an approximate string search for the substring PDDFFU.

Accordingly and by utilizing such a fuzzy searching technique, certain similarities between different metric fingerprints may be identified that might otherwise be missed. For example, while two metric fingerprints may have the same or substantially similar shape of signal, the two signals may be slightly shifted in time due to measurement particulars, system behavior, or other reasons. In these cases, searching for an exact match of metric fingerprints would not capture this similarity, while utilizing approximate string matching may identify such similarity. In different examples, the length of the substring (such as the number of characters) that is searched may be adjusted based on computing system characteristics, empirical search results, or any other suitable criteria.

By comparing the metric fingerprints for a plurality of computing devices over the same observation period, an anomaly in the performance characteristic in one or more of the computing devices may be easily identified. For example, the metric fingerprints for each computing device of a cluster of computing devices may be compared to identify similarities and differences. If the metric fingerprint of one or more of the members does not show a threshold level of similarity as compared to the metric fingerprints of the other members, then an alert may be generated.

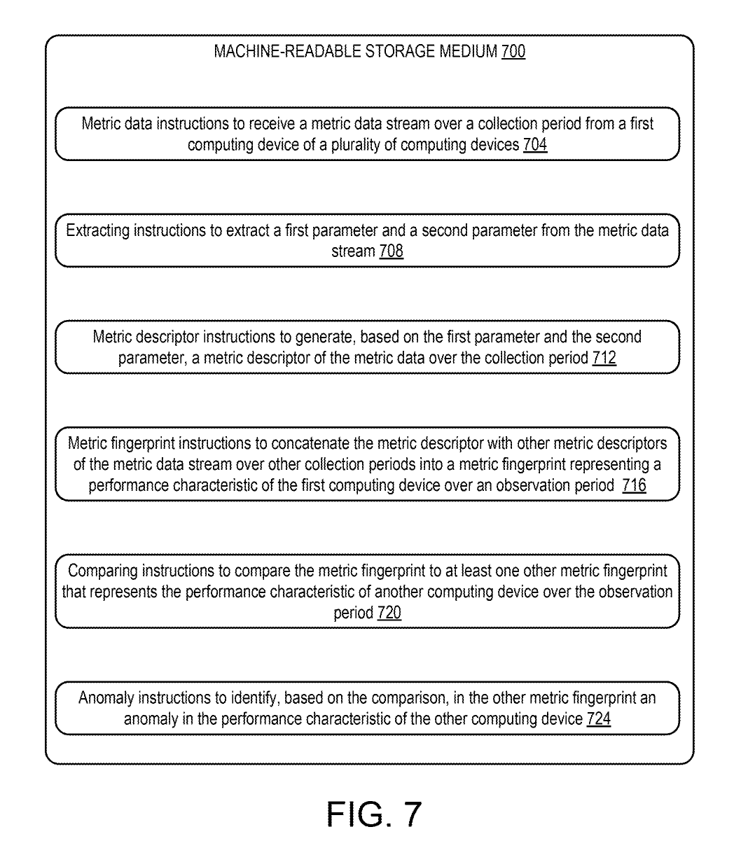

In one example and with reference to FIGS. 4, 5 and 6, metric data streams of the network throughput for 3 webservers over the same observation period of one day (24 hours) beginning at 06:00 hours are illustrated. In this example, a collection period of one hour may be utilized. A metric data stream for each webserver may comprise throughput samples and may be smoothed as described above to generate the signals shown in FIGS. 4, 5 and 6.

As shown in FIG. 6, using a metric fingerprint determined as described above, three peaks P may be identified near 01:00, 02:00 and 03:00 on the x-axis. Neither of such peaks are identified in the metric fingerprints of Webserver1 or Webserver2 corresponding to the signals shown in FIG. 4 and FIG. 5, respectively. Accordingly and by comparing the metric fingerprints in this manner, three anomalies in the throughput of Webserver3 between approximately 01:00 and 03:00 may be identified.

Accordingly, by determining and generating metric fingerprints in this manner, in some examples multiple thousands of metric data streams from hundreds and thousands of computing devices may be quickly searched based on identified similarities and differences among their metric fingerprints. Additionally and by utilizing such metric fingerprints, a computing system that is monitoring metric data streams from hundreds and thousands of computing devices may receive and process a constant stream of updated metric data in an effective and efficient manner.

In some examples, utilizing metric fingerprints as described in the present disclosure enables a computing system to easily vary searching and analysis criteria. For example, the duration of an observation period may be modified to allow for different views of metric fingerprints across different timeframes. In one example, an input may be received to modify the duration of an observation period from one day to one week. In response to the input, the duration of the observation period may be modified to a duration of one week. Correspondingly, the number of collection periods in the series of collection periods that define the observation period may be correspondingly modified to collect metric data over one the one week period.

In this manner, the granularity of metric data analysis may be easily adjusted to reflect a variety of timeframes across which metric fingerprints may be searched, compared and otherwise analyzed. For example, trends across shorter and longer observation periods may be easily collected and elucidated using such metric fingerprints. Additionally, collecting data in this manner may also enable efficient searching of individual metrics across multiple devices and applications.

It will be appreciated that the example implementations shown in FIGS. 1-6 and described above are provided as examples, and that many variations in the details of these implementations are possible.

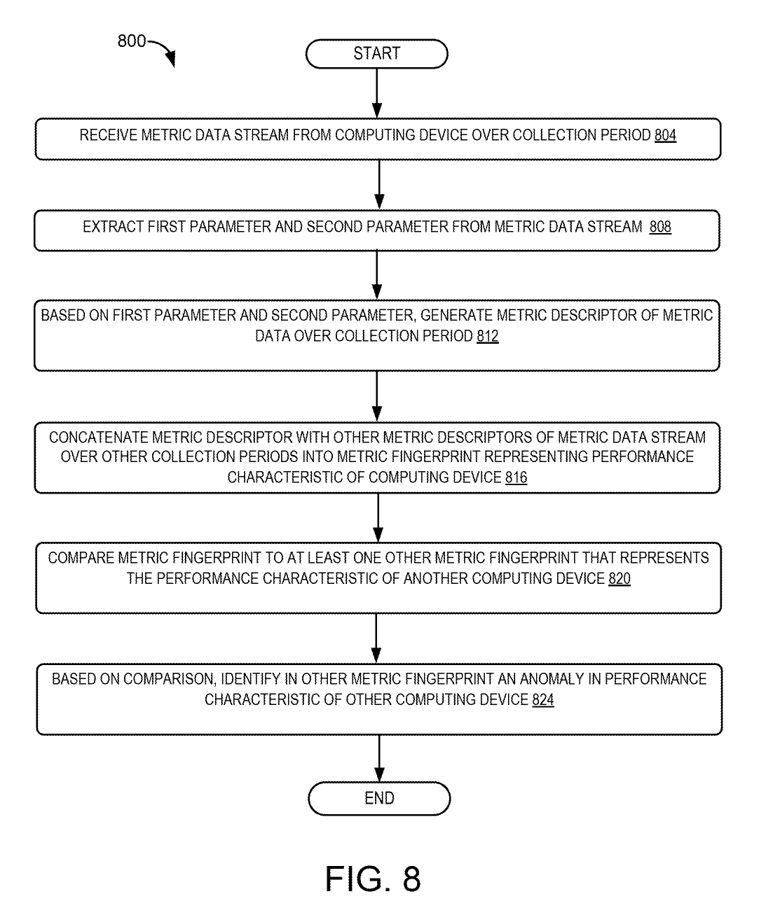

With reference now to FIG. 7, a block diagram of a non-transitory machine-readable storage medium 700 containing instructions according to an example of the present disclosure is provided. In some examples and with reference also to the computing system 10 illustrated in FIG. 1, the non-transitory machine-readable storage medium 700 may comprise instructions executable by logic subsystem 14. When executed by a logic subsystem, such instructions may identify an anomaly in the performance characteristic of a computing device in a manner consistent with the following example and other examples described herein.

In the example of FIG. 7, the instructions of non-transitory machine-readable storage medium 700 may include, at 704, metric data instructions to receive a metric data stream over a collection period from a first computing device of a plurality of computing devices. The instructions of non-transitory machine-readable storage medium 700 may include, at 708, extracting instructions to extract a first parameter and a second parameter from the metric data stream. The instructions of non-transitory machine-readable storage medium 700 may include, at 712, metric descriptor instructions to generate, based on the first parameter and the second parameter, a metric descriptor of the metric data over the collection period. The instructions of non-transitory machine-readable storage medium 700 may include, at 716, metric fingerprint instructions to concatenate the metric descriptor with other metric descriptors of the metric data stream over other collection periods into a metric fingerprint representing a performance characteristic of the first computing device over an observation period.

The instructions of non-transitory machine-readable storage medium 700 may include, at 720, comparing instructions to compare the metric fingerprint to at least one other metric fingerprint that represents the performance characteristic of another computing device over the observation period. The instructions of non-transitory machine-readable storage medium 700 may include, at 724, anomaly instructions to identify, based on the comparison, in the other metric fingerprint an anomaly in the performance characteristic of the other computing device.

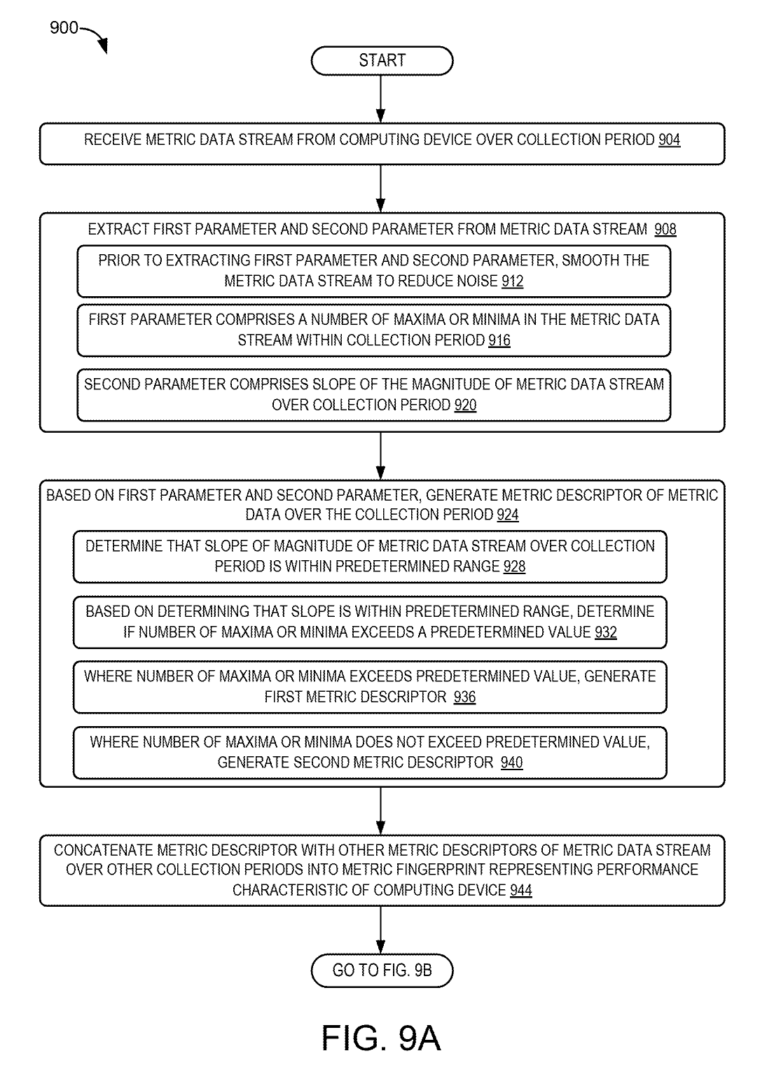

Turning now to FIG. 8, a flow chart of a method 800 for identifying in a metric fingerprint an anomaly in the performance characteristic of a computing device according to another example of the present disclosure is provided. The following description of method 800 is provided with reference to the software and hardware components described above and shown in FIGS. 1-7. The method 800 may be executed in the form of instructions encoded on a non-transitory machine-readable storage medium that is executable by a processor. It will be appreciated that method 800 may also be performed in other contexts using other suitable hardware and software components.

With reference to FIG. 8, at 804 the method 800 may include receiving a metric data stream from a computing device over a collection period. At 808 the method 800 may include extracting a first parameter and a second parameter from the metric data stream. At 812 the method 800 may include, based on the first parameter and the second parameter, generating a metric descriptor of the metric data over the collection period. At 816 the method 800 may include concatenating the metric descriptor with other metric descriptors of the metric data stream over other collection periods into a metric fingerprint representing a performance characteristic of the computing device.

At 820 the method 800 may include comparing the metric fingerprint to at least one other metric fingerprint that represents the performance characteristic of another computing device. At 824 the method 800 may include, based on the comparison, identifying in the other metric fingerprint an anomaly in the performance characteristic of the other computing device.

It will be appreciated that method 800 is provided by way of example and is not meant to be limiting. Therefore, it is to be understood that method 800 may include additional and/or other elements than those illustrated in FIG. 8. Further, it is to be understood that method 800 may be performed in any suitable order. Further still, it is to be understood that at least one element may be omitted from method 800 without departing from the scope of this disclosure.

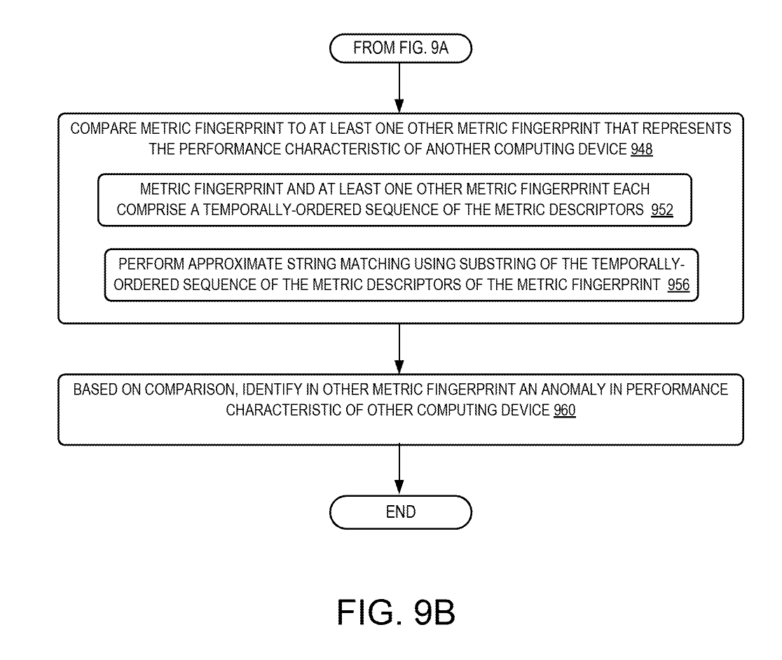

With reference now to FIGS. 9A and 9B, a flow chart of a method 900 for identifying in a metric fingerprint an anomaly in the performance characteristic of a computing device according to another example of the present disclosure is provided. The following description of method 900 is provided with reference to the software and hardware components described above and shown in FIGS. 1-7. The method 900 may be executed in the form of instructions encoded on a non-transitory machine-readable storage medium that is executable by a processor. It will be appreciated that method 900 may also be performed in other contexts using other suitable hardware and software components.

With reference to FIG. 9A, at 904 the method 900 may include receiving a metric data stream from a computing device over a collection period. At 908 the method 900 may include extracting a first parameter and a second parameter from the metric data stream. At 912 the method 900 may include, prior to extracting the first parameter and the second parameter from the metric data stream, smoothing the metric data stream to reduce noise. At 916 the method 900 may include wherein the first parameter comprises a number of maxima or minima in the metric data stream within the collection period. At 920 the method 900 may include wherein the second parameter comprises a slope of a magnitude of the metric data stream over the collection period.

At 924 the method 900 may include, based on the first parameter and the second parameter, generating a metric descriptor of the metric data over the collection period. At 928 the method 900 may include determining that the slope of the magnitude of the metric data stream over the collection period is within a predetermined range. At 932 the method 900 may include, based on determining that the slope is within the predetermined range, determining if the number of the maxima or the minima exceeds a predetermined value. At 936 the method 900 may include, where the number of the maxima or the minima exceeds the predetermined value, generating a first metric descriptor. At 940 the method 900 may include, where the number of the maxima or the minima does not exceed the predetermined value, generating a second metric descriptor.

At 944 the method 900 may include concatenating the metric descriptor with other metric descriptors of the metric data stream over other collection periods into a metric fingerprint representing a performance characteristic of the computing device. With reference now to FIG. 9B, at 948 the method 900 may include comparing the metric fingerprint to at least one other metric fingerprint that represents the performance characteristic of another computing device. At 952 the method 900 may include wherein the metric fingerprint and the at least one other metric fingerprint each comprise a temporally-ordered sequence of the metric descriptors.

At 956 the method 900 may include wherein comparing the metric fingerprint to the at least one other metric fingerprint comprises performing approximate string matching using a substring of the temporally-ordered sequence of the metric descriptors of the metric fingerprint. At 960 the method 900 may include, based on the comparison, identifying in the other metric fingerprint an anomaly in the performance characteristic of the other computing device.

It will be appreciated that method 900 is provided by way of example and is not meant to be limiting. Therefore, it is to be understood that method 900 may include additional and/or other elements than those illustrated in FIGS. 9A and 9B. Further, it is to be understood that method 900 may be performed in any suitable order. Further still, it is to be understood that at least one element may be omitted from method 900 without departing from the scope of this disclosure.

The subject matter of the present disclosure includes all novel and nonobvious combinations and subcombinations of the various processes, systems and configurations, and other features, functions, acts, and/or properties disclosed herein, as well as any and all equivalents thereof.

1. A method, comprising:
receiving a metric data stream from a computing device over a collection period;
extracting a first parameter and a second parameter from the metric data stream;
based on the first parameter and the second parameter, generating a metric descriptor of the metric data over the collection period;
concatenating the metric descriptor with other metric descriptors of the metric data stream over other collection periods into a metric fingerprint representing a performance characteristic of the computing device;
comparing the metric fingerprint to at least one other metric fingerprint that represents the performance characteristic of another computing device; and
based on the comparison, identifying in the other metric fingerprint an anomaly in the performance characteristic of the other computing device.

2. The method of claim 1, wherein the metric fingerprint and the at least one other metric fingerprint each comprise a temporally-ordered sequence of the metric descriptors.

3. The method of claim 2, wherein comparing the metric fingerprint to the at least one other metric fingerprint comprises performing approximate string matching using a substring of the temporally-ordered sequence of the metric descriptors of the metric fingerprint.

4. The method of claim 1, comprising, prior to extracting the first parameter and the second parameter from the metric data stream, smoothing the metric data stream to reduce noise.

5. The method of claim 1, wherein the first parameter comprises a number of maxima or minima in the metric data stream within the collection period.

6. The method of claim 5, wherein the second parameter comprises a slope of a magnitude of the metric data stream over the collection period.

7. The method of claim 6, wherein generating the metric descriptor of the metric data over the collection period comprises:
determining that the slope of the magnitude of the metric data stream over the collection period is within a predetermined range; and
based on determining that the slope is within the predetermined range, determining if the number of the maxima or the minima exceeds a predetermined value.

8. The method of claim 7, comprising:
where the number of the maxima or the minima exceeds the predetermined value, generating a first metric descriptor; and
where the number of the maxima or the minima does not exceed the predetermined value, generating a second metric descriptor.

9. A system for identifying an anomaly in a performance characteristic of at least one computing device, the system comprising:
a logic subsystem; and
a storage subsystem comprising instructions executable by the logic subsystem to:
for each computing device of a plurality of computing devices:
receive a metric data stream over a collection period;
for each collection period of a series of collection periods, extract a first parameter and a second parameter from the metric data stream;
based on the first parameter and the second parameter, generate a metric descriptor of the metric data received in each of the collection periods; and
generate a metric fingerprint comprising a concatenation of the metric descriptors for each of the collection periods, the metric fingerprint representing the performance characteristic over an observation period;
compare the metric fingerprint of each of the computing devices to the other metric fingerprints of each other computing device of the plurality of computing devices; and
based on the comparisons, identify the anomaly in the performance characteristic of the at least one computing device.

10. The system of claim 9, wherein the collection periods are serially ordered to define the observation period.

11. The system of claim 10, wherein the instructions are executable by the logic subsystem further to modify a duration of the observation period.

12. The system of claim 9, wherein the instructions are executable by the logic subsystem to compare the metric fingerprint of each of the computing devices to the other metric fingerprints of each other computing device by performing approximate string matching using a substring of the metric fingerprint.

13. The system of claim 9, wherein the first parameter comprises a number of maxima or minima in the metric data stream within the collection period, wherein each of the maxima or the minima is defined by a magnitude of change of the first parameter within a window period shorter than the collection period.

14. The system of claim 9, wherein the second parameter comprises a slope of a magnitude of the metric data stream over the collection period.

15. A non-transitory machine-readable storage medium encoded with instructions executable by a processor, the storage medium comprising:
metric data instructions to receive a metric data stream over a collection period from a first computing device of a plurality of computing devices;
extracting instructions to extract a first parameter and a second parameter from the metric data stream;
metric descriptor instructions to generate, based on the first parameter and the second parameter, a metric descriptor of the metric data over the collection period;
metric fingerprint instructions to concatenate the metric descriptor with other metric descriptors of the metric data stream over other collection periods into a metric fingerprint representing a performance characteristic of the first computing device over an observation period;
comparing instructions to compare the metric fingerprint to at least one other metric fingerprint that represents the performance characteristic of another computing device over the observation period; and
anomaly instructions to identify, based on the comparison, in the other metric fingerprint an anomaly in the performance characteristic of the other computing device.

16. The non-transitory machine-readable storage medium of claim 15, wherein the metric fingerprint and the at least one other metric fingerprint each comprise a temporally-ordered sequence of the metric descriptors.

17. The non-transitory machine-readable storage medium of claim 16, wherein the comparing instructions compare the metric fingerprint to the at least one other metric fingerprint by at least performing approximate string matching using a substring of the temporally-ordered sequence of the metric descriptors of the metric fingerprint.

18. The non-transitory machine-readable storage medium of claim 15, wherein the first parameter comprises a number of maxima or minima in the metric data stream within the collection period.

19. The non-transitory machine-readable storage medium of claim 18, wherein the second parameter comprises a slope of a magnitude of the metric data stream over the collection period.

20. The non-transitory machine-readable storage medium of claim 19, wherein the metric descriptor instructions generate the metric descriptor of the metric data over the collection period by at least:
determining that the slope of the magnitude of the metric data stream over the collection period is within a predetermined range; and
based on determining that the slope is within the predetermined range, determining if the number of the maxima or the minima exceeds a predetermined value.
